(19) United States
(12) Patent Application Publication
(10) Pub. No.: US 2025/0228274 A1
(43) Pub. Date: Jul. 17, 2025

(54) ZINC-ENRICHED KONJAC NOODLES

(71) Applicant: gengyun li, cupertino, CA (US)

(72) Inventor: gengyun li, cupertino, CA (US)

(21) Appl. No.: 18/412,530

(22) Filed: Jan. 14, 2024

(51) Int. Cl. A23L 19/10; A23L 29/00

(52) U.S. Cl. CPC A23L 19/115; A23L 29/015; A23L 29/065

(57) ABSTRACT

The present invention discloses zinc-enriched konjac noodles. The zinc-enriched konjac noodles comprises calcium hydroxide, konjac fiber and zinc-enriched yeast. The zinc-enriched konjac noodles is made using a method involving the following steps: mixing konjac fiber, calcium hydroxide, and zinc-enriched yeast thoroughly. The method further includes adding the above mixture into water. The method also includes uniformly stirring and heating the mixture with water to form a gel consistency. The method includes pouring gel into noodle molds. The method further includes cooling the gel to room temperature and forming zinc-enriched konjac noodles.

### FIELD OF THE INVENTION

The present invention relates to a food product and more particularly relates to zinc-enriched konjac noodles.

### BACKGROUND OF THE INVENTION

Konjac noodles are rich in fiber, calcium, and have zero starch, sugar and calories making them a popular choice for those looking to reduce their calorie intake. However, the traditional konjac noodles are identified as lacking in zinc, which is an essential mineral for human beings. Thus, the individuals that consume konjac noodles tend to lack in adequate zinc intake, particularly the vegetarians and diabetic patients. Hence, it is necessary to consume the required amount of zinc while they intake the konjac noodles.

Traditionally, the konjac noodles are made using following steps:

Heating 2 cups of water into a large cooking pot, adding and stirring calcium hydroxide in the water for one minute, adding the Konjac Glucomannan powder in the above liquid, stirring the liquid continuously until the mixture turn into a gel, pouring the gel into a noodle mold and cooling the gel. Being a thermally stable (non-reversible) gel, this gel cannot dissolve at room temperature. Optionally, when the gel is formed, the gel is cut into small pieces or into desired shape and then the gel is cooled down.

The above mentioned konjac noodles lack in zinc supplement, thus people including vegetarian, diabetic patients may not be able to consume adequate amount of zinc nutrient from the konjac noodles. Therefore, it is necessary to produce konjac noodles that is rich in zinc supplement.

### BRIEF SUMMARY OF THE INVENTION

It is an object of the present invention to provide konjac noodles enriched with essential nutrients.

It is another object of the present invention to provide individuals including vegetarian, diabetic patients and zinc deficient people with konjac noodles that is abundant in nutrients including fiber, calcium and zinc.

It is further object of the present invention to enhance the nutritional value of konjac noodles by increasing zinc supplement in the noodles.

The present invention discloses zinc-enriched konjac noodles. The zinc-enriched konjac noodles comprises calcium hydroxide, konjac fiber and zinc-enriched yeast. The zinc-enriched konjac noodles is made using a method involving the following steps: mixing konjac fiber, calcium hydroxide, and zinc-enriched yeast thoroughly. The method further includes adding the above mixture into water. The method also includes uniformly stirring and heating the mixture with water to form a gel consistency. The method includes pouring gel into noodle molds. The method further includes cooling the gel to room temperature and forming zinc-enriched konjac noodles.

### DETAILED DESCRIPTION OF THE INVENTION

The novel feature(s) which are believed to be characteristic of the invention together with the advantages will be better understood from the following description.

The present invention is intended to improve the nutritional content of konjac noodles by increasing the zinc content, facilitating easier absorption in the human body. In one embodiment, the invention discloses zinc-enriched konjac noodles containing a nutrient composition. These noodles, enriched with nutrients, provide a nutritional boost for vegetarians, diabetics, and individuals with zinc intake challenges. In a particular aspect of the invention, the konjac noodles consist of konjac fiber, calcium hydroxide, and zinc-enriched yeast, are combined in powdered form and transformed into zinc-enriched konjac noodles through a process involving mixing, stirring, heating, molding, shaping, and cooling.

The disclosed food product aims to significantly increase zinc content, providing flavorful zinc nutrition, especially beneficial for vegetarians, diabetics and individuals with insufficient zinc intake.

According to an exemplary embodiment of the present invention, the zinc-enriched konjac noodles includes calcium hydroxide, konjac fiber and zinc-enriched yeast.

The zinc-enriched konjac noodles is made using a method involving the following steps: thoroughly mixing konjac fiber, calcium hydroxide, and zinc-enriched yeast. In one embodiment, the ingredients are said to be in powdered form. The above mixture is added into water, wherein the quantity of water can be varied according to individual requirements. The mixture is uniformly stirred and heated with water to form a gel consistency. The gel is poured into noodle molds. The gel is cooled to room temperature to form zinc-enriched konjac noodles.

Among various types of zinc including organic (zinc sulfate), inorganic (zinc lactate) and zinc-enriched yeast that are available, the present invention includes zinc-enriched yeast to enrich the konjac noodles. In zinc-enriched yeast, zinc is naturally absorbed and transformed during yeast growth, resulting in pure zinc with significantly higher absorption rates than organic and inorganic zinc, thus enhancing the nutritional value while preserving the characteristic taste and texture of the noodles.

For example, to prepare 250 grams of zinc-enriched konjac noodles, a composition of about 0.7 gram of calcium hydroxide, 9 grams of konjac fiber and 0.5 gram (20,000 ppm) of zinc-enriched yeast is mixed together into 300 ml of room temperature water. The above composition of zinc-enriched yeast contains about 10 mg zinc. The quantity of water can be varied according to individual requirements. The mixture is stirred and heated to form gel consistent, cooled in room temperature and shaped using a mold to form zinc-enriched konjac noodles.

In infants and children, zinc deficiency can lead to symptoms such as diarrhea, stunted growth, and diminished appetite. Those who experienced zinc deficiency in their early years may encounter reproductive issues as adults. Additionally, in older children, zinc deficiency is associated with hair loss and increased susceptibility to infections.

As stipulated by the U. S. Department of Health & Human services, the daily upper limit of zinc intake in adults, combining all the food sources, is 40 mg. The zinc-enriched konjac noodles is one kind of healthy foods that help people easily consume adequate zinc. In the above example, it can be seen that the zinc composition in konjac noodles made using the present invention is 10 gram per zinc bag, which is up to the government prescribed limit.

The Dietary Guidelines for Americans, established by the federal government, emphasize that the primary source of nutrients for individuals should be from food and beverages. Low zinc levels are frequently observed in individuals with type 2 diabetes. Studies indicate that the use of zinc supplements could potentially contribute to the reduction of blood sugar and cholesterol levels. Nevertheless, further research is required to determine whether recommending zinc is advisable for individuals with type 2 diabetes. Source: https://ods.od.nih.gov/factsheets/Zinc-Consumer/

1. The zinc-enriched konjac noodles, comprising:
calcium hydroxide;
konjac fiber; and
zinc-enriched yeast,
wherein the zinc-enriched konjac noodles is made using a method involving following steps:
mixing konjac fiber, calcium hydroxide, and zinc-enriched yeast thoroughly;
adding the above mixture into water;
uniformly stirring and heating the mixture with water to form a gel consistency;
pouring the gel into noodle molds; and
cooling the gel to room temperature and forming zinc-enriched konjac noodles.

2. The Zinc-enriched konjac noodles of claim 1, wherein the zinc-enriched yeast includes about 1 to 40 milligrams of zinc per 250 gram konjac noodles.
